(19) United States
(12) Patent Application Publication
(10) Pub. No.: US 2026/0017133 A1
(43) Pub. Date: Jan. 15, 2026

(54) Automated Functional Fault Localization Method For Software Product Lines

(71) Applicant: South China University of Technology, Guangzhou (CN)

(72) Inventors: Yi XIANG, Guangzhou (CN); Haining WANG, Guangzhou (CN); Han HUANG, Guangzhou (CN); Jie CAO, Guangzhou (CN); Shuzhong CUI, Guangzhou (CN); Yuanbo ZHAO, Guangzhou (CN)

(73) Assignee: South China University of Technology, Guangzhou (CN)

(21) Appl. No.: 18/985,067

(22) Filed: Dec. 18, 2024

(30) Foreign Application Priority Data
Jul. 12, 2024 (CN) 202410931424.3

(51) Int. Cl. G06F 11/07; G06F 8/41; G06F 11/3668

(52) U.S. Cl. CPC G06F 11/079; G06F 8/427; G06F 11/3688

(57) ABSTRACT

An automated functional fault localization method for software product lines integrates techniques such as Spectrum-Based Fault Localization (SBFL), machine learning algorithms, data mining, and information theory. By utilizing code blocks as the detection granularity, it performs probability allocation from three perspectives: prediction, actual execution, and correlation. The suspiciousness values of code blocks are then computed using uncertainty reasoning algorithms, enabling the rapid identification of suspicious statements. Building on this, a more precise assessment of these statements is achieved by evaluating at three levels of granularity: global, local, and code block. This ultimately results in more efficient and accurate fault localization. The code blocks directly correspond to internal feature interactions, significantly enhancing the efficiency of searching for these interactions. For program statements with a higher likelihood of causing software errors, this method allows for quick identification and localization without manual intervention, thereby facilitating the maintenance of software product line systems.

### CROSS REFERENCE TO THE RELATED APPLICATIONS

This application is based upon and claims priority to Chinese Patent Application No. 202410931424.3, filed on Jul. 12, 2024, the entire contents of which are incorporated herein by reference.

### TECHNICAL FIELD

The present invention relates to the technical field of software debugging and analysis, particularly to an automated functional fault localization method for software product lines.

### BACKGROUND

A software product line refers to a collection of software-intensive systems that share a set of manageable common features. These systems satisfy specific market or task requirements and are developed from a set of core common codes in a predefined manner. Compared to traditional independent development, development from scratch, or arbitrary development models, adopting a software product line technique can significantly enhance production efficiency and economic benefits. Therefore, software product lines are a development technology that enables efficient software development and personalized customization. Many large-scale software systems, such as Linux and SQLite3, are developed based on software product line technology.

Different functions of a software product line can be abstracted into different features. Users can generate software products that meet their requirements by enabling or disabling corresponding features. Although the software product line technique can effectively improve software development efficiency, their maintenance difficulty is higher and more complex compared to conventional single-system development models. The primary reason is that bugs in software product lines are variable; buggy statements do not cause all products to fail, and bugs only manifest when certain feature interactions occur. Software faults may lead to significant issues in software development, causing errors, crashes, and data loss. To ensure software reliability, it is necessary to locate these variable bugs. However, as the software scale increases, potential feature interactions grow exponentially, and the difficulty of locating corresponding bugs rises sharply. Therefore, efficiently and automatically implementing fault localization in software product lines is of great significance.

Existing technologies for fault localization in software product lines have the following deficiencies:

Scarcity of Functional Fault Localization Techniques: Compared to non-functional fault localization in software product lines, techniques targeting functional fault localization are relatively sparse.

(2) Neglect of Feature Interactions in Common Fault Localization: Common fault localization techniques for single-system software, such as Spectrum-Based Fault Localization (SBFL), ignore the impact of feature interactions. SBFL is a widely used fault localization method in software systems. It works by collecting program spectra—a set of program entities and the number of times they are executed during program execution. SBFL locates faults in software by collecting program coverage information and execution results.

Since SBFL identifies faults based on general program execution patterns without considering the specific situations of feature interactions in software product lines, it may not accurately identify bugs that only appear under specific feature combinations, leading to reduced accuracy in defect identification. The performance of SBFL is poor when directly applied to fault localization in software product lines.

Inefficiency in Comprehensive Feature Consideration: When locating feature interactions that contain buggy statements, comprehensively considering all potential features can make the maintenance process overly inefficient.

Therefore, there is an urgent need to provide an automated functional fault localization method for software product lines to solve the above technical problems.

### SUMMARY

In view of the problems existing in the prior art, the present invention provides an automated functional fault localization method for software product lines. SBFL technology and combined with uncertainty reasoning algorithms and information theory techniques, it achieves more accurate and efficient fault localization and vulnerabilities in software product lines.

The technical solution of the present invention is implemented as follows:

The present invention provides an automated functional fault localization method for software product lines, applied to software that has failed testing. The software includes a feature library and at least several products. The feature library comprises multiple features, and the products include several functions, wherein several of these features are applied within the functions. After testing the products using test cases, test data is generated. The test data includes program spectrum files, and the test cases include passing and failing cases. The program spectrum files record the execution details of each statement in the program, including whether it was executed and the number of times it was executed. The method includes the following steps:

T1: Parse the internal feature composition of all functions, representing the internal code of the functions as code blocks. Construct a code block space and store the code blocks into this code block space.

A software product line is a development technique that abstracts parts of a software system's functions into features. Users can select the desired features (functions) to generate the products (a software system) they want.

Multiple products within the same software product line share and apply a common set of features.

Different features may control the implementation of the same function under different circumstances. A function consists of one or more features, that is, multiple features (functions) collaborate to achieve a process or goal.

T2: Calculate the suspicious values of the code blocks, including predictive suspicious values, runtime suspicious values, and correlation suspicious values.

The predictive suspicious value is calculated as the probability that the code block causes the corresponding software product to fail, that is, calculating the posterior probability of the code block and distributing this probability. The calculation of the posterior probability is as follows:

$$p ( failed \vert b ) = \frac{N ( b , falied )}{N ( b )} , p ( b \vert failed ) = \frac{p ( failed \vert b ) p ( b )}{p ( failed )} ;$$

Where b represents a code block; N(b) denotes the number of times b is called and executed during all product tests; N(b,failed) represents the number of times b is called and executed in products that failed testing; p(failed|b) denotes the probability that b causes the product to fail the test; p(b) represents the probability that b is invoked and executed during all product tests; p(failed) denotes the occurrence probability of products failing tests among all products; p(b|failed) is the posterior probability.

The runtime suspicious value is calculated as the probability that the code block is called in the products, specifically: count the total number m of code blocks that are called and executed. Then, during testing, the runtime suspicious value of a code block that is called and executed is 1/m; for a code block that is not called and executed, the runtime suspicious value is 0.

The correlation suspicious value is calculated as the influence factor between the code block and the test results of the products, that is: construct relational pairs between the selection vector of each code block and the test result vector. Based on these relational pairs, calculate the correlation value between each code block and the test results, and perform probability distribution on the correlation values. The components of the selection vector represent the selection state of each product for the same code block; where 0 indicates that the product has not selected the current code block, and 1 indicates that the product has selected the current code block. The components of the test result vector represent the pass/fail status of each product during testing; where 0 indicates that the product has passed the current test, and 1 indicates that the product has failed the current test. The selection vector and the test result vector are denoted as Vb and R, respectively. The calculation of the correlation value is as follows:

$$S U ( Vb , R ) = 2 \times \frac{H ( Vb ) - H ( Vb \vert R )}{H ( Vb ) + H ( R )} ;$$

Where H(Vb) represents the entropy of the selection vector Vb; H(R) represents the entropy of the test result vector R; H(Vb|R) represents the conditional entropy of Vb given R. The test results include both passing and failed cases. The predictive suspicious value, runtime suspicious value, and correlation suspicious value are all decimal values between 0 and 1.

Entropy refers to information entropy. In information theory, information entropy is a measure of the uncertainty or disorder of information. The information entropy of a vector can be defined as the sum of the information entropies of its individual components.

The calculations of H(Vb), H(R), and H(Vb|R) are respectively:

$$H ( Vb ) = - {\sum }_{v ∈ Vb} p ( v ) {log}_{2} p ( v ) ;$$

$$H ( R ) = - {\sum }_{r ∈ R} p ( r ) {log}_{2} p ( r ) ;$$

$$H ( Vb \vert R ) = - {\sum }_{r ∈ R} p ( r ) {\sum }_{v ∈ Vb} p ( v \vert r ) {log}_{2} p ( v \vert r ) ;$$

Where v represents a component of Vb, and r represents a component of R; p(⋅) denotes the probability of selecting a certain component from the vector; p(v|r) represents the probability of selecting v given r.

In this scheme, the Softmax function is used to assign probabilities to the selected vectors. It converts a vector or a set of real numbers into a probability distribution such that each element's value is between 0 and 1, and the sum of all elements equals 1. For a given vector Z=[z₁, z₂, . . . , zₙ], where zᵢ is the i-th component of vector Z, the Softmax value is:

$$Softmax {( Z )}_{i} = \frac{{e}^{{z}_{i}}}{{\sum }_{j = 1}^{n} {e}^{{z}_{j}}} ;$$

Where i=1, 2, . . . , n.

In the calculation of the predictive suspicious values, the posterior probability of each code block is obtained, forming a vector. The Softmax function is applied to this vector to compute and obtain the predictive suspicious value for each code block. In the calculation of the correlation suspicious values, similarly, a vector composed of correlation values is used to compute and obtain the correlation suspicious value for each code block.

By respectively collecting several of the predictive suspicious values, the runtime suspicious values, and the correlation suspicious values, three suspicious vectors are obtained, namely, the first suspicious vector, the second suspicious vector, and the third suspicious vector.

T3: Calculating a unique suspicious vector based on the three suspicious vectors. Each parameter in the unique suspicious vector is the unique suspicious value; each code block corresponds to one unique suspicious value. Calculate the conflict factor between the first suspicious vector and the second suspicious vector;

Where, let the first suspicious vector be denoted as

$${E}_{a} = \{ {p}_{1}^{a} , {p}_{2}^{a} , ... , {p}_{i}^{a} , ... , {p}_{j}^{a} , ... , {p}_{e}^{a} \} ,$$

the second suspicious vector be denoted as

$${E}_{b} = \{ {p}_{1}^{b} , {p}_{2}^{b} , ... , {p}_{i}^{b} , ... , {p}_{j}^{b} , ... , {p}_{e}^{b} \} ,$$

p represented the suspicious value, eee represents the number of suspicious values within the suspicious vectors, and i∈[1,e], j∈[1,e]; then the calculation method for the conflict factor cf is:

$$cf = {\sum }_{i = 1}^{e} {\sum }_{j = 1}^{e} {p}_{i}^{a} {p}_{j}^{b} - {\sum }_{i = 1}^{e} {p}_{i}^{a} {p}_{j}^{b} ;$$

If the conflict factor is greater than a preset first threshold, then use an uncertainty reasoning algorithm to fuse the first suspicious vector and the third suspicious vector to obtain the unique suspicious vector; otherwise, use the uncertainty reasoning algorithm to normalize the first suspicious vector and the second suspicious vector to obtain the unique suspicious vector.

The uncertainty reasoning algorithm used is the Dempster-Shafer (DS) fusion algorithm. Uncertainty reasoning algorithms are logical and mathematical methods for handling uncertain information. Common uncertainty reasoning algorithms include Bayesian inference, evidence theory (Dempster-Shafer theory), decision trees, and others. By utilizing uncertainty reasoning algorithms, information from multiple data sources or parameters can be integrated to provide a more comprehensive and accurate assessment of the target. The calculation process is as follows:

Let Eₓ₁ represent the first suspicious vector, and E_{y1} represent the second suspicious vector or the third suspicious vector. Eₓ₁ and E_{y1} are fused through calculation to obtain a new vector E_{new1};

Then

$${p}_{i}^{new 1} = \frac{1}{1 - cf} {p}_{i}^{x 1} {p}_{i}^{y 1} ;$$

Where

$${p}_{i}^{x 1}$$

represents the i-th component in vector Eₓ₁,

$${p}_{i}^{y 1}$$

represents the i-th component in vector E_{y1}, and

$${p}_{i}^{new 1}$$

represents the i-th component in vector E_{new1};

T4: Filter the code blocks, where code blocks with unique suspicious values less than a preset target value are filtered out, and the remaining code blocks are considered suspicious code blocks. Use the program spectrum files to locate the executed program statements within the suspicious code blocks, referred to as suspicious statements; this also includes the location information of the suspicious statements. Save the suspicious statements and their location information to form a suspicious statement set.

T5: Utilize Spectrum-Based Fault Localization (SBFL) technology to perform global evaluation, local evaluation, and block evaluation on each suspicious statement in the suspicious statement set.

The global evaluation calculates the suspicious value of each suspicious statement based on the test data obtained from the global evaluation of the products, yielding a first evaluation value. Multiple first evaluation values form a first evaluation vector.

The local evaluation calculates the suspicious value of each suspicious statement based on the test data obtained from unit testing of the products, yielding a second evaluation value. Multiple second evaluation values form a second evaluation vector.

The block evaluation calculates the suspicious value of each suspicious statement based on the test data obtained from testing the code blocks, yielding a third evaluation value. Multiple third evaluation values form a third evaluation vector.

T6: Merge the first evaluation vector and the second evaluation vector into a fourth evaluation vector. Calculate the final vector based on the third evaluation vector and the fourth evaluation vector as follows: calculate the Manhattan distance between the third evaluation vector and the fourth evaluation vector. If the Manhattan distance is greater than a preset second threshold, the third evaluation vector is taken as the final vector; otherwise, fuse the third evaluation vector and the fourth evaluation vector using an uncertainty reasoning algorithm to obtain the final vector.

The fusion process is:

Let Eₓ₂ represent the third evaluation vector, and E E_{y2} represent the fourth evaluation vector; Eₓ₂ and E_{y2} are fused through calculation to obtain a new vector E_{new2}.

Then,

$${p}_{i}^{new 2} = \frac{1}{1 - md} {p}_{i}^{x 2} {p}_{i}^{y 2} ;$$

Where

$${p}_{i}^{x 2}$$

represents the i-th component in vector Eₓ₂,

$${p}_{i}^{y 2}$$

represents the iii-th component in vector E_{y2}, and

$${p}_{i}^{new 2}$$

represents the i-th component in vector E_{new2}; md represents the Manhattan distance between the third evaluation vector and the fourth evaluation vector.

Each value in the final vector corresponds to a final evaluation value, and each final evaluation value corresponds to a suspicious statement.

T7: Based on the final evaluation values, the suspicious statements are ranked, and the Top K suspicious statements are selected for output, where K is a preset positive integer.

The suspicious value is a quantified measure of the likelihood that a code block or program statement causes the software product to fail testing. This solution uses the code block as the granularity for detection, combining the calculation of the three suspicious values and the uncertainty reasoning algorithm to achieve fast fault localization. It does not require consideration of the complete, potential feature interaction space but instead focuses on internal feature interactions for localization, saving a significant amount of time otherwise spent on misalignment localization at the feature level. Additionally, the present invention enables automated fault localization based on test results, considering the suspicious evaluation values of each suspicious statement across three granularities: global, local, and code block levels. This approach results in more accurate evaluation outcomes and resolves the technical issue in SBFL, where program statements on the same path share identical suspicious values. It also achieves efficient and highly accurate localization, effectively reducing labor costs.

As a further optimization of the above solution, in step T5, the calculation method for the first evaluation value/second evaluation value is as follows:

$$Suspiciousness ( s ) = \frac{\frac{failed ( s )}{TF}}{\frac{failed ( s )}{TF} + \frac{passed ( s )}{TP}} ;$$

Where Suspiciousness(s) represents the first evaluation value/second evaluation value, s denotes the suspicious statement,

$$\frac{passed ( s )}{TP}$$

represents the number of times the suspicious statement s passed testing in the global/local evaluation, and

$$\frac{failed ( s )}{TF}$$

represents the number of times the suspicious statement s failed testing in the global/local evaluation.

The suspiciousness of a statement is determined based on its execution counts in passing and failing tests; when a suspicious statement is executed more frequently in failed tests and less frequently in passing tests, it indicates a higher level of suspicion.

The first evaluation value/second evaluation value can also be calculated using any other SBFL computation rule.

As an optimization of the above scheme, the calculation method for the third evaluation value is as follows: For several suspicious statements within the same code block, the unique suspicious value of the code block is defined as the third evaluation value of the first suspicious statement. The third evaluation values of the other suspicious statements are derived by sequentially adding a preset constant to the first suspicious statement's third evaluation value, where the preset constant can be either positive or negative.

Additionally, the calculation method for the fourth evaluation vector is optimized as follows: y=ax+(1−a)Y where y represents the fourth evaluation vector, X is the first evaluation vector, Y is the second evaluation vector, and a is a predetermined decimal representing the weight constant.

Furthermore, the location information corresponds to the line number of the feature in the feature library associated with the suspicious statement.

Compared to existing technologies, this invention achieves the following beneficial effects: This invention provides an automated functional fault localization method for software product lines that leverages code blocks as the detection granularity, along with the computation of three suspicious values and uncertainty reasoning algorithms, to enable rapid error localization without requiring consideration of the complete and potential feature interaction space. This internal feature interaction localization significantly reduces the time spent on misalignment in the feature layer.

### BRIEF DESCRIPTION OF THE DRAWINGS

FIG. 1 is a flowchart illustrating the automated functional fault localization method for software product lines provided in the embodiment of the present invention.

FIG. 2 is a flowchart depicting the process for calculating the unique suspicious vector provided in the embodiment of the present invention.

FIG. 3 is a flowchart showing the method for calculating the final vector as described in the embodiment of the present invention.

FIG. 4 is a diagram illustrating the construction of relationship pairs provided in the embodiment of the present invention.

### DETAILED DESCRIPTION OF THE EMBODIMENTS

In order to make the objectives, technical solutions, and advantages of the present invention clearer, the following description will provide a clear and complete explanation of the technical solutions in the embodiments of the present invention in conjunction with the accompanying drawings. It is evident that the described embodiments are only a portion of the embodiments of the present invention and do not represent all embodiments. All other embodiments derived by those skilled in the art based on the embodiments of the present invention, without creative labor, fall within the scope of protection of the present invention.

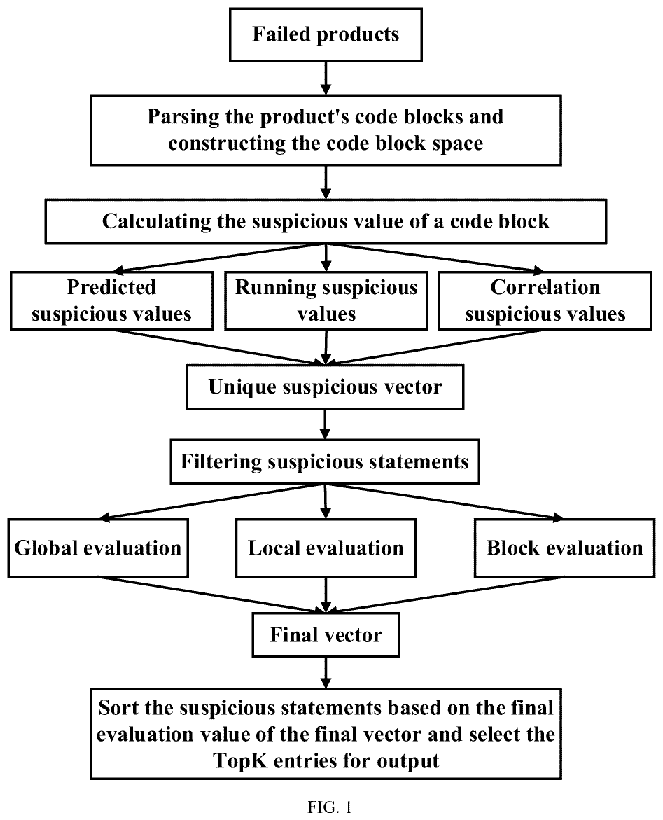

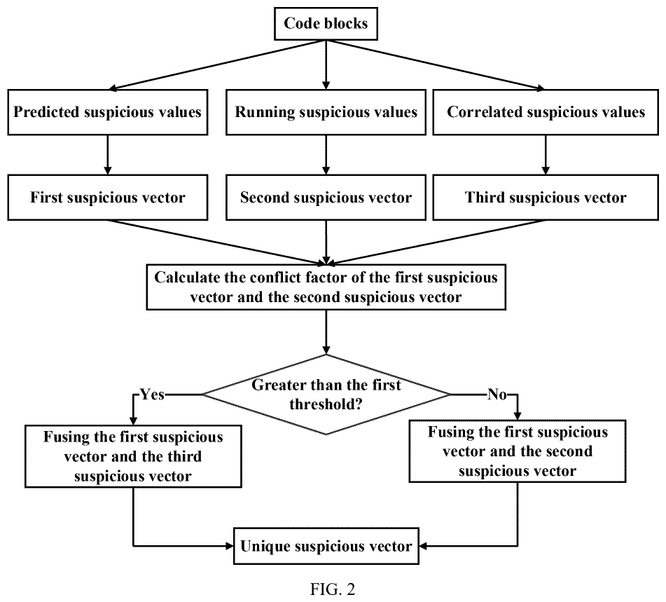

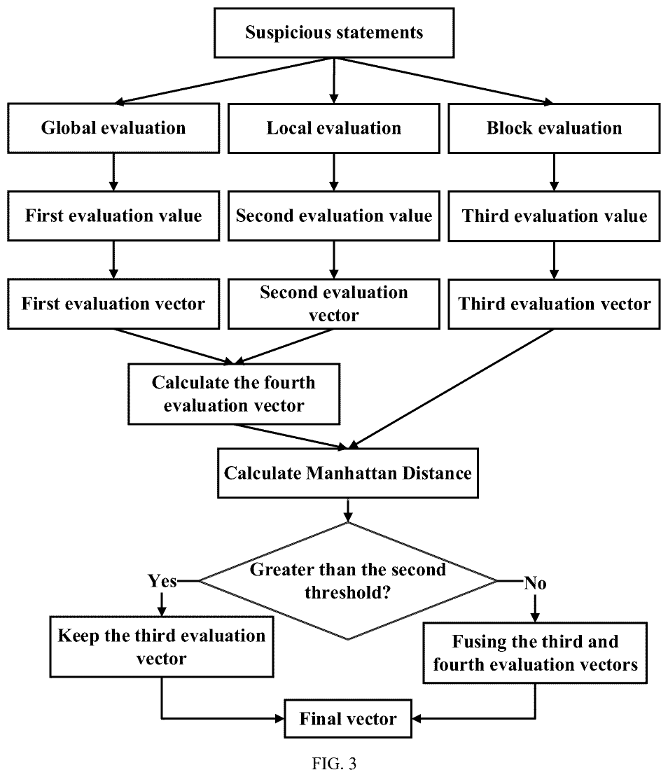

As shown in FIGS. 1 to 4, the embodiment of the present invention provides an automated functional fault localization method for software product lines, applied to software that has failed testing. The software includes a feature library and at least several products. The feature library comprises several features, and the products include multiple functions that apply these features.

After testing the products using test cases, test data is generated. The test data includes program spectrum files, which record the execution status of each statement in the program, including whether it was executed and the execution count. The method includes the following steps:

T1: Analyze the feature composition within all functions, representing the internal code of functions as code blocks. Construct a code block space and store the code blocks in this space. The code block space records the code blocks in the form of a hash table.

A software product line is a development technology that abstracts certain functionalities of the software system into features, allowing users to select desired features to generate customized products (a software system). Multiple products within the same software product line share a common set of features. Different features may control the implementation of the same functionality under various conditions. A function is composed of one or more features, where multiple features collaborate to achieve a process or goal.

T2: Calculate the suspicious values of the code blocks, including predictive suspicious values, operational suspicious values, and correlation suspicious values. The predictive suspicious value calculates the probability of errors in the corresponding product due to the code block.

In this embodiment, the calculation of the predictive suspicious value involves computing the posterior probability of the code block and performing probability distribution on the posterior probability. The calculation of the posterior probability is as follows:

$$p ( f ai l ed \vert b ) = \frac{N ( b , f ai l ed )}{N ( b )} , p ( b \vert f ai l ed ) = \frac{p ( f ai l ed \vert b ) p ( b )}{p ( f ai l ed )} ;$$

where N(⋅) denotes the number of occurrences of an event; b represents a code block; N(b) denotes the number of times b is called during tests of all products; N(b,failed) indicates the number of times b is called in products that failed tests; p(failed|b) represents the probability that b causes the product to fail testing; p(b) is the probability of b being called in all product tests; p(failed) is the probability of encountering products that failed tests; and p(b|failed) is the posterior probability.

The operational suspicious value calculates the probability of the code block being called in the product. The calculation of the operational suspicious value is as follows: count the total number of code blocks executed, denoted as m; thus, the operational suspicious value for the called code blocks during testing is 1/m, while the operational suspicious value for the blocks that were not called is 0.

In calculating the operational suspicious value, existing program analysis tools, such as Javalang, may be utilized to analyze and record the functions executed during unit testing. First, for each failed unit test, obtain its Abstract Syntax Tree (AST). The AST allows for the analysis of all executed functions, including constructors, common functions of the product line, and functions located within try blocks. It is important to note that functions not belonging to the product line, such as “assertTrue,” “assertFalse,” and “assertEquals” from Junit testing frameworks, are not recorded. Additionally, repeated occurrences of a function are recorded only once. Subsequently, the corresponding code blocks are derived from the hash table obtained in T1. Since constructors are frequently executed, an average probability distribution is assigned to all executed functions, meaning that all executed code blocks share the same suspicious probability.

The correlation suspicious value calculates the influence factor between the code block and the test results of the products. The test results include both passing and failing outcomes. The predictive suspicious value, operational suspicious value, and correlation suspicious value are all decimal values within the range of [0, 1].

In this embodiment, the calculation of the correlation suspicious value involves constructing a relationship pair between the selection vector of each code block and the test results vector. Based on this relationship pair, the correlation value for each code block with respect to the test results is computed, and the correlation values are subsequently assigned. The components of the selection vector indicate whether each product has selected the same code block. Here, a value of 0 indicates that the product did not select the current code block, while a value of 1 indicates that the product did select it. The components of the test results vector represent the pass status of each product during testing; a value of 0 indicates that the product passed the current test, while a value of 1 indicates that it did not.

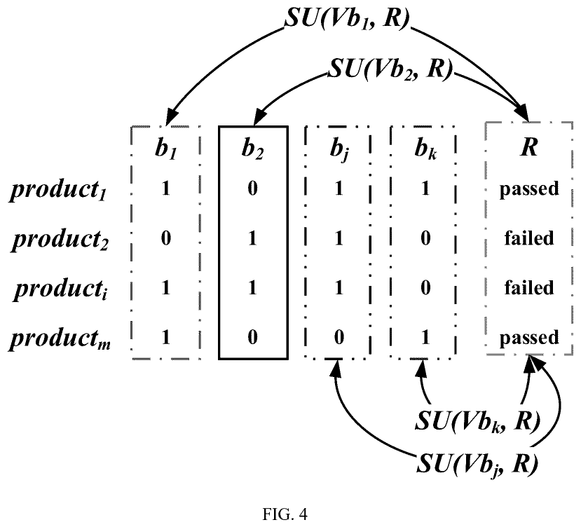

The selection vector and test results vector are denoted as Vb and R, respectively. For clarity, a simple example is provided in FIG. 4, which includes m products and k code blocks. For example, the selection vector for code block b1 is [1,0,1,1] [1, 0, 1, 1] [1,0,1,1] based on its selection status across each product. Correspondingly, the vector R can be determined based on the test results of each product, yielding [1,0,0,1] [1, 0, 0, 1] [1,0,0,1], where 1 indicates a pass and 0 indicates a failure. Thus, a two-dimensional relationship pair can be represented as [[1,0,1,1], [1,0,0,1]][[1, 0, 1, 1], [1, 0, 0, 1]][[1,0,1,1], [1,0,0,1]].

The calculation of the correlation value is as follows:

$$SU ( Vb , R ) = 2 \times \frac{H ( Vb ) - H ( Vb \vert R )}{H ( Vb ) + H ( R )} ;$$

Where H(Vb) represents the entropy of Vb; H(R) represents the entropy of R; and H(Vb|R) represents the entropy of Vb given R. The correlation method employed here is based on the Symmetric Uncertainty metrics. SU(Vb,R) indicates the degree to which code block Vb influences test failures.

Entropy in information theory measures the uncertainty or disorder of information. The entropy of a vector can be defined as the sum of the entropies of its individual components.

The calculations for H(Vb), and H(Vb|R) are as follows:

$$\begin{matrix}H ( Vb ) = - {\sum }_{v ∈ Vb} p ( v ) {log}_{2} p ( v ) ; \\ H ( R ) = - {\sum }_{r ∈ R} p ( r ) {log}_{2} p ( r ) ; \\ H ( Vb \vert R ) = - {\sum }_{r ∈ R} p ( r ) {\sum }_{v ∈ Vb} p ( v \vert r ) {log}_{2} p ( v \vert r ) ;\end{matrix}$$

Where v represents the components of Vb, and r represents the components of R; p(⋅) denotes the probability of selecting a specific component from the vector; p(v|r) denotes the probability of selecting v given r.

In this scheme, the Softmax function is utilized for probability distribution assignment of the selected vector. It transforms a vector or a set of real numbers into a probability distribution, ensuring that each element's value falls between 0 and 1, and the sum of all elements equals 1. For a given vector Z=[z₁, z₂, . . . , zₙ], where zᵢ is the i-th component of vector Z, the Softmax value is defined as:

$${Softmax ( Z )}_{i} = \frac{{e}^{{z}_{i}}}{{\sum }_{j = 1}^{n} {e}^{{z}_{i}}} ;$$

Where i ranges from 1 to n.

In the calculation of the predicted suspicious values, the posterior probability for each code block is obtained, forming a vector. This vector is then processed through the Softmax function to derive the predicted suspicious values for each code block. Similarly, the calculation of the correlation suspicious values involves constructing a vector based on the correlation values, from which the correlation suspicious values for each code block are determined.

The predicted suspicious values, run suspicious values, and correlation suspicious values are aggregated to form three suspicious vectors, referred to as the first suspicious vector, the second suspicious vector, and the third suspicious vector.

T3. The unique suspicious vector is computed from the three suspicious vectors. Each parameter of the unique suspicious vector corresponds to a unique suspicious value, with one code block associated with one unique suspicious value.

Specifically, the conflict factor between the first suspicious vector and the second suspicious vector is calculated. The conflict factor represents the credibility of the synthesis of multi-source evidence, with a value ranging from 0 to 1; values closer to 1 indicate greater conflict between the pieces of evidence.

Let the first suspicious vector be represented as

$${E}_{a} = \{ {p}_{1}^{a} , {p}_{2}^{a} , ... , {p}_{i}^{a} , ... , {p}_{j}^{a} , ... , {p}_{e}^{a} \}$$

and the second suspicious vector as

$${E}_{b} = \{ {p}_{1}^{b} , {p}_{2}^{b} , ... , {p}_{i}^{b} , ... , {p}_{j}^{b} , ... , {p}_{e}^{b} \} .$$

Let p denote the suspicious value, e represent the number of suspicious values within the suspicious vector, and i∈[1,e], j∈[1,e].

The calculation method for the conflict factor cf is as follows:

$$cf = {\sum }_{i = 1}^{e} {\sum }_{j = 1}^{e} {p}_{i}^{a} {p}_{j}^{b} - {\sum }_{i = 1}^{e} {p}_{i}^{a} {p}_{j}^{b} ;$$

If the conflict factor is greater than a predetermined first threshold, such as 0.95, it indicates that the first suspicious vector and the second suspicious vector are in conflict. In this case, the uncertainty reasoning algorithm is used to merge the first suspicious vector and the third suspicious vector to obtain the unique suspicious vector.

Otherwise, the uncertainty reasoning algorithm is applied to normalize the first suspicious vector and the second suspicious vector, resulting in the unique suspicious vector.

In this embodiment, the uncertainty reasoning algorithm employed is the Dempster-Shafer (DS) fusion algorithm. The computation process is as follows:

Let Eₓ₁ represent the first suspicious vector, and E_{y1} represent the second suspicious vector or the third suspicious vector. The fusion of Eₓ₁ and E_{y1} results in a new vector E_{new1}.

Then,

$${p}_{i}^{new 1} = \frac{1}{1 - cf} {p}_{i}^{x 1} {p}_{i}^{y 1} ;$$

where

$${p}_{i}^{x 1}$$

denotes the i-th component of vector Eₓ₁,

$${p}_{i}^{y 1}$$

denotes the i-th component of vector E_{y1}, and

$${p}_{i}^{new 1}$$

denotes the i-th component of vector E_{new1}.

The uncertainty reasoning algorithm is a logical and mathematical method for processing uncertain information. Common uncertainty reasoning algorithms include Bayesian inference, Dempster-Shafer theory, and decision trees. By utilizing uncertainty reasoning algorithms, it is possible to integrate information from multiple data sources or parameters, providing a more comprehensive and accurate assessment of the target.

T4. To filter the code blocks, those with a unique suspicious value less than a preset target value are filtered out, leaving the remaining code blocks as suspicious code blocks. The program spectrum file is then used to locate the executed program statements within these suspicious code blocks, identified as suspicious statements. This process also includes the location information of the suspicious statements; in this embodiment, the location information corresponds to the line number of the features in the feature library.

The suspicious statements and their location information are saved to form a collection of suspicious statements. Specifically, in step T41, the Python library xml.etree.ElementTree is selected for analyzing the program spectrum. ElementTree can abstract the program spectrum (saved in XML format) into an element tree. It retrieves the elements with the tag “line” under the “project” node, which indicate the execution status of program statements. To access the executed statements within suspicious blocks, the corresponding function can be identified using the “signature” attribute. Since only specific lines contain the “signature” attribute, a boolean variable is set to determine whether the executed function is a suspicious function.

T42. Next, since there may be erroneous counts in the program spectrum information, it is necessary to determine whether each statement has a “truecount” attribute. If the “truecount” attribute exists, it indicates that the statement has been counted incorrectly. When a statement is incorrectly counted, its “truecount” value is checked to see if it is greater than 0. If there is no erroneous count, the “count” attribute is evaluated to determine if its value is greater than 0. Statements that meet the above conditions will have their corresponding line numbers recorded in the product.

T43. Each suspicious statement in the products is mapped to the corresponding statement under its feature. Similarly based on the program spectrum information, the difference in this step is that the entire product's program spectrum is analyzed, whereas in T42, the program spectrum under unit tests is analyzed. The ElementTree library is used to parse the program spectrum into an element tree, retrieving the “line” nodes under the “project” node. If the nodes correspond to the program statements obtained in T42, the “featureClass” and “featureLineNum” attributes are used to obtain the feature and corresponding line number of each statement, which are stored in a dictionary in the format of (feature.line number).

T5. Using SBFL technology, each suspicious statement in the collection is subjected to global evaluation, local evaluation, and block evaluation. SBFL, s.t., Spectrum-based Fault Localization, is a fault localization technique based on program spectra.

The global evaluation calculates the suspicious values of the statements based on the test data obtained from the overall assessment of the product, resulting in the first evaluation values. Multiple first evaluation values form the first evaluation vector.

The local evaluation calculates the suspicious values of the statements based on unit test data from the product, resulting in the second evaluation values. Multiple second evaluation values form the second evaluation vector.

In this embodiment, the calculation method for the first evaluation value/second evaluation value is:

$$Suspiciousness ( s ) = \frac{\frac{failed ( s )}{T F}}{\frac{failed ( s )}{T F} + \frac{passed ( s )}{T P}} ;$$

Where Suspiciousness(s) represents the first evaluation value/second evaluation value; s denotes the suspicious statement;

$$\frac{passed ( s )}{T P}$$

indicates the number of times the suspicious statement passed testing in the global/local evaluation;

$$\frac{failed ( s )}{T F}$$

indicates the number of times the suspicious statement failed testing in the global/local evaluation.

The suspiciousness of a statement is determined by its execution counts in passing and failing tests; a higher number of executions in failing tests, combined with a lower number in passing tests, suggests higher suspiciousness for that statement.

For block evaluation, the suspicious values of the statements are calculated based on test data from the code block, resulting in the third evaluation values. In this embodiment, the calculation method for the third evaluation value is as follows: for several suspicious statements within the same code block, the unique suspicious value of the block is assigned as the third evaluation value of the first suspicious statement.

Using the third evaluation value of the first suspicious statement as a baseline, subsequent suspicious statements receive their third evaluation values by adding or subtracting a preset constant, which may be either positive or negative. Multiple third evaluation values then form the third evaluation vector. Thus, the suspicious value of the first suspicious statement in the code block is assigned as the block's suspicious value, while subsequent suspicious statements' values are adjusted by a small constant.

T6. Merge the first evaluation vector and the second evaluation vector to form the fourth evaluation vector. In this embodiment, the calculation method for the fourth evaluation vector is defined as: y=aX+(1−a)Y;

where y represents the fourth evaluation vector, X represents the first evaluation vector, Y represents the second evaluation vector, and a is a pre-defined decimal representing the weight constant.

Subsequently, calculate the final vector using the third evaluation vector and the fourth evaluation vector; each value in the final vector corresponds to a final evaluation value, which in turn corresponds to a suspicious statement.

Specifically, compute the Manhattan distance between the third evaluation vector and the fourth evaluation vector. The Manhattan distance of the two vectors is calculated using the L1 norm, which is the sum of the absolute differences across all dimensions.

If the Manhattan distance exceeds a predefined second threshold, the third evaluation vector is designated as the final vector.

Otherwise, employ an uncertainty reasoning algorithm to merge the third evaluation vector and the fourth evaluation vector to obtain the final vector. In this instance, the uncertainty reasoning algorithm also utilizes the Dempster-Shafer (DS) fusion algorithm, defined as follows:

Let Eₓ₂ represent the third evaluation vector and E_{y2} represent the fourth evaluation vector; the fusion of Eₓ₂ and E_{y2} yields a new vector E_{new2}.

Then

$${p}_{i}^{new 2} = \frac{1}{1 - md} {p}_{i}^{x 2} {p}_{i}^{y 2} ;$$

where

$${p}_{i}^{x 2}$$

represents the i-th component of vector Eₓ₂,

$${p}_{i}^{y 2}$$

represents the iii-th component of vector E_{y2}, and

$${p}_{i}^{new 2}$$

represents the i-th component of vector E_{new2}; md denotes the Manhattan distance between the third evaluation vector and the fourth evaluation vector.

T7. Based on the final evaluation values, sort the suspicious statements and select the top K suspicious statements for output, where K is a predetermined positive integer value. The suspicious value quantifies the likelihood that a code block or program statement causes the software product to fail testing. This approach leverages the detection strength of code blocks, combining the calculations of three types of suspicious values with an uncertainty reasoning algorithm to achieve rapid fault localization without needing to consider the complete potential feature interaction space. By focusing on internal feature interactions, it saves substantial time in fault localization at the feature level. Moreover, the invention facilitates automated fault localization based on testing results while accounting for the suspicious evaluation values of each suspicious statement across global, local, and block granularities, yielding more accurate assessment outcomes. This addresses the technical issue in SBFL where program statements along the same path exhibit identical suspicious values, while achieving efficient and precise localization, thus effectively reducing labor costs.

According to the disclosures and teachings presented in this specification, those skilled in the art may also make variations and modifications to the aforementioned embodiments. Therefore, the invention is not limited to the specific embodiments revealed and described above; any modifications and variations of the invention should fall within the protective scope of the claims. Furthermore, although certain specific terminology has been used in this specification, such terminology is for convenience of explanation only and does not limit the invention.

1. An automated functional fault localization method for software product lines, applied to software product that has failed testing; the software product line comprises a feature library and at least several products, wherein the feature library comprises multiple features, and the products comprise several functions, with several of the features applied within the functions; after testing the products using test cases, test data is generated; the test data comprises program spectrum files, and the test cases comprise both passing and failing cases; the automated functional fault localization method comprises the following steps:
T1: parsing a feature structure tree (FST) of all functions, and representing an internal code of the functions as code blocks; wherein a code block space is constructed, and code blocks are stored in the code block space;
T2: calculating suspicious values of the code blocks, comprising a predictive suspicious value, a runtime suspicious value, and a correlation suspicious value;
wherein the predictive suspicious value is calculated as a probability that the code block causes the corresponding product to fail, which is equivalent to calculating a posterior probability of the code block, followed by probabilistic distribution of the posterior probability; the posterior probability is calculated as follows:
$$p ( passed \vert b ) = \frac{N ( b , passed )}{N ( b )} , p ( b \vert failed ) = \frac{p ( failed \vert b ) p ( b )}{p ( failed )} ;$$
wherein b represents the code block; N(b) represents a number of times b executed during all product tests; N(b,failed) represents a number of times b executed in failing product tests; p(failed|b) represents a probability that b causes the product to fail the test; p(b) represents a probability that b is executed during all product tests; p(failed) represents a probability of a product failing across all product tests; and p(b|failed) is the posterior probability;
the runtime suspicious value is calculated as a probability that the code block is executed in the product; wherein a total number of executed code blocks during testing is denoted as m; therefore, the runtime suspicious value for a code block that is executed during testing is 1/m, while the runtime suspicious value for a code block that is not executed during testing is 0;
the correlation suspicious value is calculated as an influence factor between the code block and test results of the product by: constructing relational pairs between a selection vector of each code block and a test result vector; based on the relational pairs, calculating a correlation value between each code block and the test results, and performing probabilistic distribution on correlation values;
components of the selection vector represent a selection state of each product for a same code block; components of the test result vector represent a pass/fail status of each product during testing; the selection vector and the test result vector are denoted as Vb and R, respectively; the correlation value is calculated as follows:
$$SU ( Vb , R ) = 2 \times \frac{H ( Vb ) - H ( Vb \vert R )}{H ( Vb ) + H ( R )} ;$$
wherein H(Vb) represents an entropy of the selection vector Vb; H(R) represents an entropy of the test result vector R; and H(Vb|R) represents a conditional entropy of Vb given R; the test results comprise both passing and failing cases; the correlation value is calculated based on these entropies, reflecting the relationship between the code block selection and the test results; and
several of predictive suspicious values, runtime suspicious values, and correlation suspicious values are aggregated to form three suspicious vectors comprising a first suspicious vector, a second suspicious vector and a third suspicious vector, respectively;
T3: calculating a unique suspicious vector based on the three suspicious vectors; wherein each parameter in the unique suspicious vector represents a unique suspicious value, with each code block corresponding to one unique suspicious value; additionally, a conflict factor between the first suspicious vector and the second suspicious vector is calculated;
wherein let the first suspicious vector be denoted as
$${E}_{a} = \{ {p}_{1}^{a} , {p}_{2}^{a} , … , {p}_{i}^{a} , … , {p}_{j}^{a} , … , {p}_{e}^{a} \} ,$$
and the second suspicious vector as
$${E}_{b} = \{ {p}_{1}^{b} , {p}_{2}^{b} , … , {p}_{i}^{b} , … , {p}_{j}^{b} , … , {p}_{e}^{b} \} ;$$
let p represent the suspicious value, e represents a number of suspicious values within the suspicious vectors, and i∈[1,e], j∈[1,e]; then a calculation method for the conflict factor cf is:
$$cf = {\sum }_{i = 1}^{e} {\sum }_{j = 1}^{e} {p}_{i}^{a} {p}_{j}^{b} - {\sum }_{i = 1}^{e} {p}_{i}^{a} {p}_{j}^{b} ;$$
when the conflict factor is greater than a preset first threshold, an uncertainty reasoning algorithm is used to fuse the first suspicious vector and the third suspicious vector to obtain the unique suspicious vector; when the conflict factor is less than or equal to the preset first threshold, the uncertainty reasoning algorithm is used to normalize the first suspicious vector and the second suspicious vector to obtain the unique suspicious vector;
the uncertainty reasoning algorithm employs a Dempster-Shafer (DS) fusion algorithm, and a calculation process is as follows:
let Eₓ₁ represent the first suspicious vector, and E_{y1} represent the second suspicious vector or the third suspicious vector; and Eₓ₁ and E_{y1} are fused through calculation to obtain a first new vector E_{new1};
then
$${p}_{i}^{n e w 1} = \frac{1}{1 - cf} {p}_{i}^{x 1} {p}_{i}^{y 1} ;$$
wherein
$${p}_{i}^{x 1}$$
represents an i-th component in Eₓ₁,
$${p}_{i}^{y 1}$$
represents an i-th component in E_{y1}, and represents an i-th component in E_{new1};
$${p}_{i}^{n e w 1}$$
T4: filtering the code blocks, wherein code blocks with unique suspicious values less than a preset target value are filtered out, and the remaining code blocks are considered suspicious code blocks; using the program spectrum files to locate the executed program statements within the suspicious code blocks, referred to as suspicious statements; also comprising location information of the suspicious statements; saving the suspicious statements and the location information to obtain a suspicious statement set;
T5: utilizing Spectrum-Based Fault Localization (SBFL) technology to perform global evaluation, local evaluation, and block evaluation on each suspicious statement in the suspicious statement set, respectively;
wherein the global evaluation involves calculating the suspicious value of the suspicious statement based on the test data obtained from the global evaluation of the product, yielding a first evaluation value; multiple first evaluation values form a first evaluation vector;
the local evaluation involves calculating the suspicious value of the suspicious statement based on the test data obtained from unit testing of the product, yielding a second evaluation value; multiple second evaluation values form a second evaluation vector; and
the block evaluation involves calculating the suspicious value of the suspicious statement based on the test data obtained from testing of the code blocks, yielding a third evaluation value; multiple third evaluation values form a third evaluation vector;
T6: merging the first evaluation vector and the second evaluation vector into a fourth evaluation vector; calculating a final vector based on the third evaluation vector and the fourth evaluation vector, comprising: calculating a Manhattan distance between the third evaluation vector and the fourth evaluation vector; when the Manhattan distance is greater than a preset second threshold, the third evaluation vector is taken as the final vector; when the Manhattan distance is less than or equal to the preset second threshold, the uncertainty reasoning algorithm is used to fuse the third evaluation vector and the fourth evaluation vector to obtain the final vector;
wherein a fusion process is:
let Eₓ₂ represent the third evaluation vector, and E_{y2} represent the fourth evaluation vector; Eₓ₂ and E_{y2} are fused through calculation to obtain a second new vector E_{new2};
then
$${p}_{i}^{n e w 2} = \frac{1}{1 - md} {p}_{i}^{x 2} {p}_{i}^{y2} ;$$
wherein
$${p}_{i}^{x 2}$$
represents an i-th component in Eₓ₂,
$${p}_{i}^{y 2}$$
represents an i-th component in E_{y2}, and
$${p}_{i}^{n e w 2}$$
represents an i-th component in E_{new2}; and md denotes the Manhattan distance between the third evaluation vector and the fourth evaluation vector; and
each value in the final vector is a final evaluation value, and each final evaluation value corresponds to a suspicious statement; and
T7: sorting the suspicious statements based on final evaluation values and selecting Top K suspicious statements for output, wherein K is a preset positive integer value.

2. The automated functional fault localization method for the software product lines according to claim 1, wherein, in step T5, a calculation method of the first evaluation value or the second evaluation value is:
$$Suspiciousness ( s ) = \frac{\frac{failed ( s )}{TF}}{\frac{failed ( s )}{TF} + \frac{passed ( s )}{TP}} ;$$
wherein Suspiciousness(s) represents the first evaluation value or the second evaluation value; s denotes the suspicious statement;
$$\frac{passed ( s )}{TP}$$
represents a number of times the suspicious statement has passed tests in the global evaluation or the local evaluation; and
$$\frac{failed ( s )}{TF}$$
represents a number of times the suspicious statement has failed tests in the global evaluation or the local evaluation.

3. The automated functional fault localization method for the software product lines according to claim 1, wherein a calculation method of the third evaluation value is:
for multiple suspicious statements within the same code block, the unique suspicious value of the code block is the third evaluation value of the first suspicious statement;
the third evaluation value of the first suspicious statement is used as a reference, and a preset constant is sequentially added to obtain the third evaluation values of the other suspicious statements; and
the preset constant is a positive or negative number.

4. The automated functional fault localization method for the software product lines according to claim 1, wherein a calculation method of the fourth evaluation vector is: y=ax+(1−a)Y;
wherein y represents the fourth evaluation vector; X represents the first evaluation vector;
Y represents the second evaluation vector; and a is a pre-set decimal number representing a weighting constant.

5. The automated functional fault localization method for the software product lines according to claim 1, wherein the location information is a line number of the corresponding feature of the suspicious statement in the feature library.
